(19) United States
(12) Patent Application Publication
(10) Pub. No.: US 2022/0100004 A1
(43) Pub. Date: Mar. 31, 2022

(54) COLOR VISION CORRECTION LENS AND OPTICAL COMPONENT

(71) Applicant: Panasonic Intellectual Property Management Co., Ltd., Osaka (JP)

(72) Inventor: Hideki WADA, Osaka (JP)

(73) Assignee: Panasonic Intellectual Property Management Co., Ltd., Osaka (JP)

(21) Appl. No.: 17/424,558

(22) PCT Filed: Jan. 23, 2020
(86) PCT No.: PCT/JP2020/002234

§ 371 Date: Jul. 21, 2021

(30) Foreign Application Priority Data
Feb. 26, 2019 (JP) 2019-033326

(51) Int. Cl. G02C 7/10; G02B 5/22

(52) U.S. Cl. CPC G02C 7/108; G02B 5/223

(57) ABSTRACT

A color vision correction lens (1) includes: a first resin layer (10) having a convex surface (10a); and a second resin layer (20) stacked on the convex surface (10a). The first resin layer (10) includes an absorbing material (12) that absorbs light in a first wavelength band (90). The second resin layer (20) includes a fluorescent material (22) that emits fluorescence in a second wavelength band (92). The first wavelength band (90) and the second wavelength band (92) overlap at least partially.

### TECHNICAL FIELD

The present invention relates to a color vision correction lens and an optical component.

### BACKGROUND ART

Conventionally, eyeglass lenses for aiding the color differentiation ability of people with color vision deficiency have been known. For example, Patent Literature (PTL) 1 discloses an eyeglass lens for people with color vision deficiency which has, on the surface of the eyeglass lens, a partial reflection film having an optical spectral curve that monotonically increases or monotonically decreases the transmittance of a wavelength band that corresponds to a color that the people with color vision deficiency have difficulty differentiating.

### CITATION LIST

### Patent Literature

[PTL 1] Japanese Unexamined Patent Application Publication No. 2002-303832

### SUMMARY OF INVENTION

### Technical Problem

However, the aforementioned conventional eyeglass lens for people with color vision deficiency has a deeply tinted appearance, and therefore other people tend to find the appearance of the eyeglass lens somewhat odd.

In view of the above, the present disclosure aims to provide a color vision correction lens and an optical component which have a less deeply tinted appearance.

### Solution to Problem

In order to provide such a color vision correction lens, a color vision correction lens according to an aspect of the present invention includes: a first resin layer having a convex surface; and a second resin layer stacked on the convex surface. In the color vision correction lens, the first resin layer includes an absorbing material that absorbs light in a first wavelength band, the second resin layer includes a fluorescent material that emits fluorescence in a second wavelength band, and the first wavelength band and the second wavelength band overlap at least partially.

In addition, an optical component according to an aspect of the present invention includes the color vision correction lens.

### Advantageous Effects of Invention

According to the present invention, it is possible to provide a color vision correction lens, etc. which have a less deeply tinted appearance.

### BRIEF DESCRIPTION OF DRAWINGS

FIG. 1 is a schematic cross-sectional view illustrating a color vision correction lens according to an embodiment.

FIG. 2 is a diagram illustrating an example of an absorption spectrum of an absorbing material of the color vision correction lens according to the embodiment.

FIG. 3 is a diagram illustrating an example of an absorption spectrum of a dye material of the color vision correction lens according to the embodiment.

FIG. 4 is a diagram illustrating an example of an excitation spectrum and a fluorescence spectrum of a fluorescent material of the color vision correction lens according to the embodiment.

FIG. 5 is a diagram illustrating an example of a relationship between the absorption spectrum of the absorbing material of the color vision correction lens according to the embodiment and the fluorescence spectrum of the fluorescent material of the color vision correction lens according to the embodiment.

FIG. 6 is a diagram illustrating another example of the relationship between an absorption spectrum of the absorbing material of the color vision correction lens according to the embodiment and a fluorescence spectrum of the fluorescent material of the color vision correction lens according to the embodiment.

FIG. 7 is a diagram illustrating another example of the relationship between an absorption spectrum of the absorbing material of the color vision correction lens according to the embodiment and a fluorescence spectrum of the fluorescent material of the color vision correction lens according to the embodiment.

FIG. 8 is a diagram illustrating another example of the relationship between an absorption spectrum of the absorbing material of the color vision correction lens according to the embodiment and a fluorescence spectrum of the fluorescent material of the color vision correction lens according to the embodiment.

FIG. 9 is a diagram illustrating another example of the relationship between an absorption spectrum of the absorbing material of the color vision correction lens according to the embodiment and a fluorescence spectrum of the fluorescent material of the color vision correction lens according to the embodiment.

FIG. 10 is a diagram illustrating optical properties of the color vision correction lens according to the embodiment.

FIG. 11 is a perspective view illustrating a pair of eyeglasses with the color vision correction lenses according to the embodiment.

FIG. 12 is a perspective view illustrating contact lenses each of which includes the color vision correction lens according to the embodiment.

FIG. 13 is a plan view illustrating an intraocular lens that includes the color vision correction lens according to the embodiment.

FIG. 14 is a perspective view illustrating a pair of goggles that includes the color vision correction lens according to the embodiment.

### DESCRIPTION OF EMBODIMENTS

Hereinafter, a color vision correction lens and an optical component according to an embodiment of the present invention will be described in detail with reference to the drawings. Note that the embodiments described below each show a specific example of the present invention. Accordingly, the numerical values, shapes, materials, structural elements, the arrangement and connection of the structural elements, steps, an order of the steps, etc. described in the following embodiments are all mere examples, and thus are not intended to limit the present invention. Thus, structural elements not recited in any one of independent claims among structural elements in the following embodiments are described as optional structural elements.

Note that the drawings are schematic diagrams, and do not necessarily provide strictly accurate illustration. Thus, the scales etc. of the drawings do not necessarily coincide. Throughout the drawings, the same reference sign is given to substantially the same configuration, and redundant description is omitted or simplified.

Throughout the description, a numerical value range, a term that indicates a relationship between structural elements, such as coincides with or be equal to, and a term that indicates the shape of a structural element, such as spherical, are not an expression that only indicates the strict meaning of the expression, but includes the scope of the expression that is substantially the same. For example, each of the expressions means to include a difference of about several percent.

### Embodiment

### Configuration

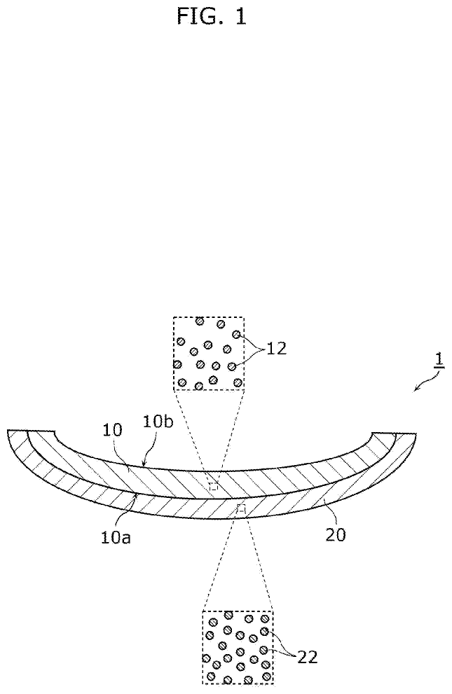

First, the configuration of a color vision correction lens according to an embodiment will be described with reference to FIG. 1.

FIG. 1 is a cross-sectional view illustrating color vision correction lens 1 according to the embodiment. As illustrated in FIG. 1, color vision correction lens 1 includes first resin layer 10 and second resin layer 20.

Color vision correction lens 1 is a lens for correcting color vision deficiency that people with color vision deficiency have. People with color vision deficiency are typically congenitally color-blind to red and green, and perceive green light more intensely than red light. Color vision correction lens 1 is capable of keeping a perceptional balance between red light and green light by reducing the transmission of green light. With this, color vision correction lens 1 can correct the color vision.

First resin layer 10 is a light-transmissive plate-like component. Specifically, first resin layer 10 is formed by molding a transparent resin material into a predetermined shape. For example, first resin layer 10 includes a resin material, such as acrylic resin, epoxy resin, urethane resin, polysilazane, siloxane, allyl diglycol carbonate (CR-39) or polysiloxane acrylic hybrid resin.

First resin layer 10 has a thickness of, for example, at least 1 mm and at most 3 mm. First resin layer 10 has convex surface 10a and concave surface 10b. The radius of curvature of convex surface 10a and concave surface 10b is at least 60 mm and at most 800 mm. Alternatively, the radius of curvature of convex surface 10a and concave surface 10b may be at least 100 mm and at most 300 mm. The radius of curvature of convex surface 10a and the radius of curvature of concave surface 10b may be different. For example, the radius of curvature of convex surface 10a may be smaller than that of concave surface 10b. In addition, convex surface 10a and concave surface 10b each have, for example, a spherical surface, but need not have a perfect spherical surface. For example, in a cross-sectional view of first resin layer 10, the roundness of convex surface 10a and concave surface 10b may be at least several μm and at most ten-odd μm.

First resin layer 10 may have a function of condensing or diffusing light, like a function performed by a convex lens or a concave lens. The size and shape of first resin layer 10 are to be, for example, the size and shape suitable for a pair of eyeglasses, a contact lens, and the like which are wearable by a person.

Note that the size and shape of first resin layer 10 are not limited to the examples presented above. For example, first resin layer 10 may have a thickness of less than 1 mm or greater than 3 mm. The thickness of first resin layer 10 may vary depending on a part of first resin layer 10. That is, first resin layer 10 may have a thin part and a thick part.

Second resin layer 20 is stacked on convex surface 10a of first resin layer 10. In the example illustrated in FIG. 1, second resin layer 20 is in contact with convex surface 10a, and is provided so as to cover the entire convex surface 10a.

Second resin layer 20 is a light-transmissive thin film layer. Second resin layer 20 is formed by hardening a resin material applied on convex surface 10a. Second resin layer 20 has a thickness of, for example, at least 10 μm and at most 100 μm, but the thickness is not limited to the above. For example, the thickness of second resin layer 20 may be at least 30 μm, and may be at most 70 μm. Second resin layer 20 has a curved shape formed along convex surface 10a. The thickness of second resin layer 20 is uniform, but may vary depending on a part of second resin layer 20, for example.

In this embodiment, second resin layer 20 and first resin layer 10 are formed using the same resin material. For this reason, the refractive index of second resin layer 20 is equal to the refractive index of first resin layer 10. This reduces the amount of light that reflects off the interface between first resin layer 10 and second resin layer 20, thereby preventing a reduction in the amount of light that transmits through color vision correction lens 1.

Note that second resin layer 20 and first resin layer 10 may be formed using different materials. For example, second resin layer 20 may be formed using a resin material which is different in type from a resin material used for forming first resin layer 10, but has a refractive index equal to the refractive index of the resin material used for forming first resin layer 10.

In FIG. 1, an enlarged view of a portion of first resin layer 10 and an enlarged view of a portion of second resin layer 20 are each schematically illustrated within a rectangular frame surrounded by a dotted line. Note that an illustration of hatching denoting a cross section of each of first resin layer 10 and second resin layer 20 is omitted within the frame surrounded by a dotted line.

In the example illustrated in FIG. 1, first resin layer 10 includes absorbing material 12. Second resin layer 20 includes fluorescent material 22. Note that FIG. 1 is a schematically illustrated diagram. Absorbing material 12 is dispersed throughout first resin layer 10 in a dissolved state. Alternatively, absorbing material 12 may be dispersed throughout first resin layer 10 in a molecular state while being atomized to form aggregate particles. Likewise, fluorescent material 22 is in either state as described above.

### Absorbing Material

Absorbing material 12 is uniformly dispersed throughout first resin layer 10. For example, absorbing material 12 is uniformly dispersed throughout the entire first resin layer 10. Alternatively, absorbing material 12 may be dispersed only in the central area of first resin layer 10 in a plan view. Note that the plan view of first resin layer 10 is a view seen from the front face of convex surface 10a of first resin layer 10. Absorbing material 12 may be dispersed only in a surface part including convex surface 10a of first resin layer 10.

Absorbing material 12 absorbs light in a first wavelength band. The first wavelength band falls within the range of from 440 nm to 600 nm. Absorbing material 12 does not substantially absorb light other than light in the first wavelength band among the visible light bands. The visible light bands fall within the range of from 380 nm to 780 nm, for example.

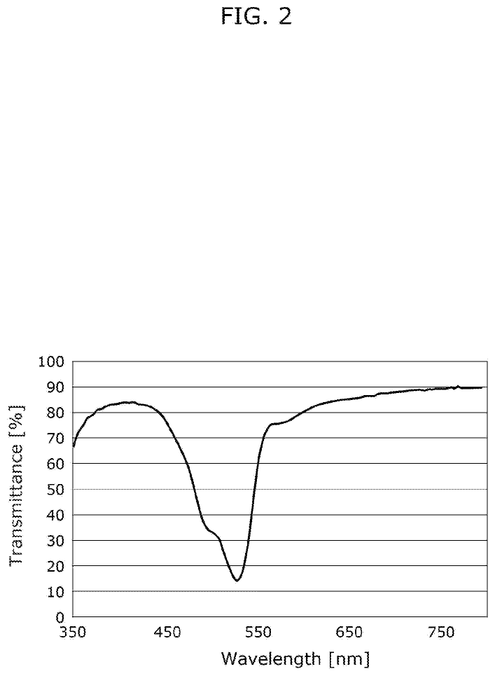

FIG. 2 is a diagram illustrating an example of an absorption spectrum of absorbing material 12 of color vision correction lens 1 according to the embodiment. In FIG. 2, the horizontal axis represents wavelength (unit: nm), and the vertical axis represents transmittance (unit: %). FIG. 2 illustrates the absorption spectrum of a plate material made of polycarbonate (e.g., first resin layer 10) throughout which absorbing material 12 is dispersed.

As illustrated in FIG. 2, the wavelength of an absorption peak (i.e., peak wavelength) of absorbing material 12 is approximately 530 nm. The transmittance at the peak wavelength is approximately 15%, which is the minimum value within a wavelength band ranging from 440 nm to 600 nm. Within the transmittance range of from 40% and to 60%, a bandwidth of the peak of absorbing material 12 falls within the range of from approximately 55 nm to approximately 79 nm.

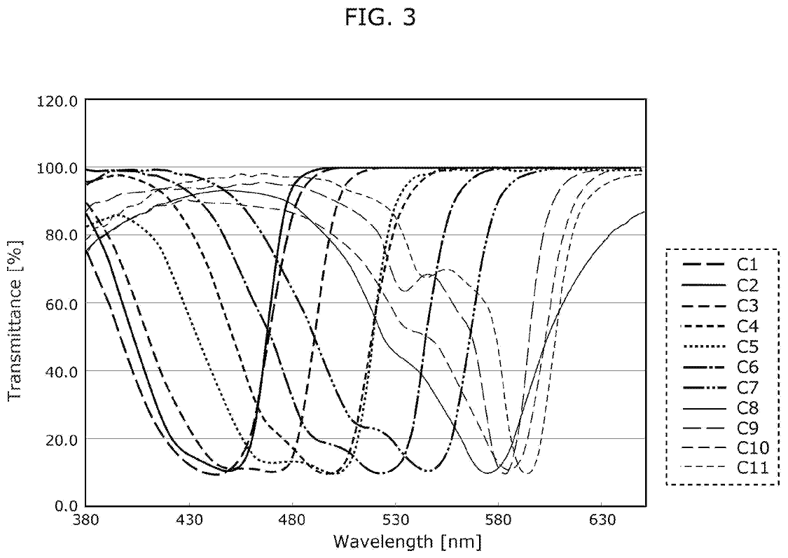

Absorbing material 12 includes at least one type of dye material, for example. FIG. 3 is a diagram illustrating an example of the absorption spectrum of a dye material that is dispersed throughout first resin layer 10 of color vision correction lens 1 according to the embodiment. FIG. 3 illustrates the absorption spectrum of plate materials made of polycarbonate throughout which each of 11 types of dye materials C1 through C11 is dispersed.

Dye materials C1 through C11 has an absorption peak that falls within the range of from 440 nm to 600 nm. For example, one type or several types of dye materials can be selected from dye materials C1 through C11 illustrated in FIG. 3, and a dye material or a mixture of dye materials mixed in a predetermined proportion can be used as absorbing material 12. A dye material that can be used as absorbing material 12 is a porphyrin-based dye, a phthalocyanine-based dye, a merocyanine-based dye, or a methine-based dye.

### Fluorescent Material

Fluorescent material 22 is uniformly dispersed throughout second resin layer 20. For example, fluorescent material 22 is uniformly dispersed throughout the entire second resin layer 20. Alternatively, when absorbing material 12 is dispersed only in a certain area of first resin layer 10, fluorescent material 22 may be dispersed in an area that overlaps the area where absorbing material 12 is dispersed in a plan view. Specifically, the area where absorbing material 12 is dispersed may coincide with the area where fluorescent material 22 is dispersed in a plan view. Fluorescent material 22 may be dispersed only in a surface part of second resin layer 20.

Fluorescent material 22 emits fluorescence in a second wavelength band. The second wavelength band falls within the range of from 440 nm to 600 nm. Fluorescent material 22 is a down-conversion phosphor material. Fluorescent material 22 is excited by excitation light having a short wavelength, and emits fluorescence having a wavelength longer than the wavelength of the excitation light.

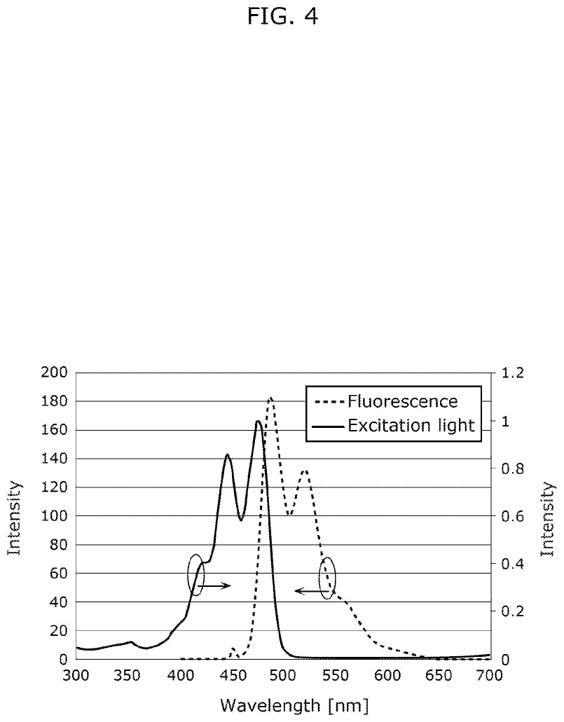

FIG. 4 is a diagram illustrating an example of an excitation spectrum and a fluorescence spectrum of fluorescent material 22 of color vision correction lens 1 according to the embodiment. In FIG. 4, the horizontal axis represents wavelength (unit: nm), and the vertical axis represents intensity (unit: %). The solid line represents excitation light and the broken line represents fluorescence.

In this embodiment, fluorescent material 22 emits fluorescence in response to reception of light having a wavelength ranging from 300 nm to 440 nm. Specifically, as illustrated in FIG. 4, the excitation spectrum of fluorescent material 22 has a peak at approximately 440 nm and at approximately 480 nm. That is, when excitation light having a high intensity at 480 nm is incident on fluorescent material 22, fluorescent material 22 emits fluorescence having a fluorescence spectrum as illustrated in FIG. 4, for example. Fluorescent material 22 has a peak wavelength of fluorescence at approximately 490 nm and at approximately 520 nm.

For example, perylene-based green fluorescent dye, coumarin-based green fluorescent dye, imidazole-based green fluorescent dye, or oxadiazole-based green fluorescent dye can be used for fluorescent material 22. Depending on the first wavelength band which is an absorption wavelength band of absorbing material 12 included in first resin layer 10, a fluorescent dye having an appropriate fluorescent wavelength can be used as fluorescent material 22. The combination of a peak wavelength in the excitation spectrum of fluorescent material 22 and a peak wavelength in the fluorescence spectrum of fluorescent material 22 is also not particularly limited. For example, fluorescent material 22 may be 7-(diethylamino)-2H-1-benzopyran-2-one whose peak wavelength of excitation light is 380 nm and whose peak wavelength of fluorescence is 464 nm. Alternatively, fluorescent material 22 may be 3-phenyl-7-(diethylamino)-2H-1-benzopyran-2-one whose peak wavelength of excitation light is 400 nm and whose peak wavelength of fluorescence is 480 nm. Moreover, for example, fluorescent material 22 may be 4-(trifluoromethyl)-7-(diethylamino) coumarin whose peak wavelength of excitation light is 403 nm and whose peak wavelength of fluorescence is 516 nm. In addition, fluorescent material 22 may be 7-(diethylamino) coumarin 3-carboxylic acid whose peak wavelength of excitation light is 423 nm and whose peak wavelength of fluorescence is 455 nm. Fluorescent material 22 may be 2-[3-[1-(5-Carboxypentyl)-3,3-dimethyl-1,3-dihydro-indol-2-ylidene]-propenyl]-3,3-dimethyl-1-propyl-3H-indolium bromide, whose peak wavelength of excitation light is 419 nm and whose peak wavelength of fluorescence is 467 nm. Furthermore, fluorescent material 22 may be 6-[(7-Diethylamino-2-oxo-2H-chromene-3-carbonyl)-amino]-hexanoic acid 2,5-dioxo-pyrrolidin-1-yl ester, whose peak wavelength of excitation light is 549 nm and whose peak wavelength of fluorescence is 563 nm.

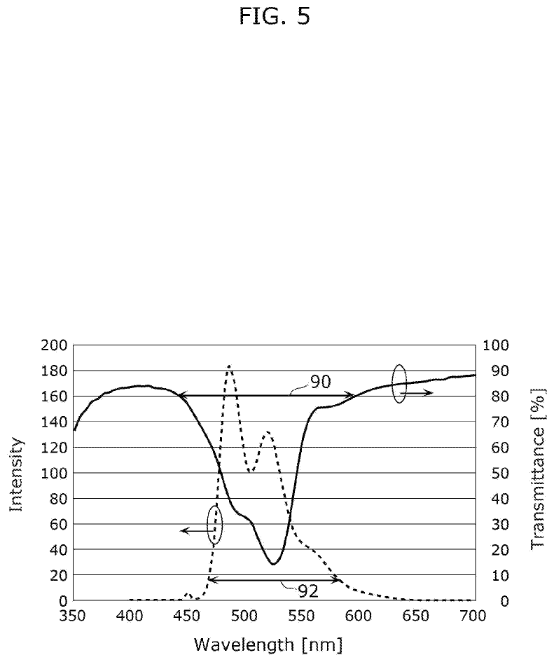

In this embodiment, as illustrated in FIG. 5, first wavelength band 90 which is the absorption wavelength band of absorbing material 12 and second wavelength band 92 which is the fluorescence wavelength band of fluorescent material 22 at least partially overlap. FIG. 5 is a diagram illustrating an example of a relationship between an absorption spectrum of absorbing material 12 of color vision correction lens 1 according to the embodiment and a fluorescence spectrum of fluorescent material 22 of color vision correction lens 1 according to the embodiment. FIG. 5 illustrates the absorption spectrum of absorbing material 12 illustrated in FIG. 2 and the fluorescence spectrum of fluorescent material 22 illustrated in FIG. 4, where the absorption spectrum of absorbing material 12 and the fluorescence spectrum of fluorescent material 22 overlap each other.

In the example illustrated in FIG. 2 and FIG. 5, first wavelength band 90 has, for example, transmittance of at most 80%. Specifically, first wavelength band 90 ranges from approximately 440 nm to approximately 600 nm. In the example illustrated in FIG. 4 and FIG. 5, second wavelength band 92 has a range in which the intensity of fluorescence is at least 10% of the peak, for example. Specifically, second wavelength band 92 ranges from approximately 470 nm to approximately 580 nm. Accordingly, second wavelength band 92 is included in first wavelength band 90.

As illustrated in FIG. 5, the peak wavelength of light absorbed by absorbing material 12 is located more toward the long wavelength side than the location of the peak wavelength of fluorescence emitted by fluorescent material 22. The peak wavelength of light absorbed by absorbing material 12 is included in second wavelength band 92 in the fluorescence spectrum of fluorescent material 22. The peak wavelength of fluorescence emitted by fluorescent material 22 is included in first wavelength band 90 in the absorption spectrum of absorbing material 12. The peak wavelength of light absorbed by absorbing material 12 may coincide with the peak wavelength of fluorescence emitted by fluorescent material 22. Alternatively, the peak wavelength of light absorbed by absorbing material 12 may be located more toward the short wavelength side than the location of the peak wavelength of fluorescence emitted by fluorescent material 22.

Note that a part of second wavelength band 92 need not be included in first wavelength band 90. FIG. 6 through FIG. 9 are diagrams illustrating different examples of the relationship between an absorption spectrum of absorbing material 12 of color vision correction lens 1 according to the embodiment and a fluorescence spectrum of fluorescent material 22 of color vision correction lens 1 according to the embodiment.

For example, as illustrated in FIG. 6, a band on the short wavelength side of second wavelength band 92 in the fluorescence spectrum and a band on the long wavelength side of first wavelength band 90 in the absorption spectrum may overlap each other. At this time, the band on the long wavelength side of second wavelength band 92 is not included in first wavelength band 90. In addition, the band on the short wavelength side of first wavelength band 90 is not included in second wavelength band 92.

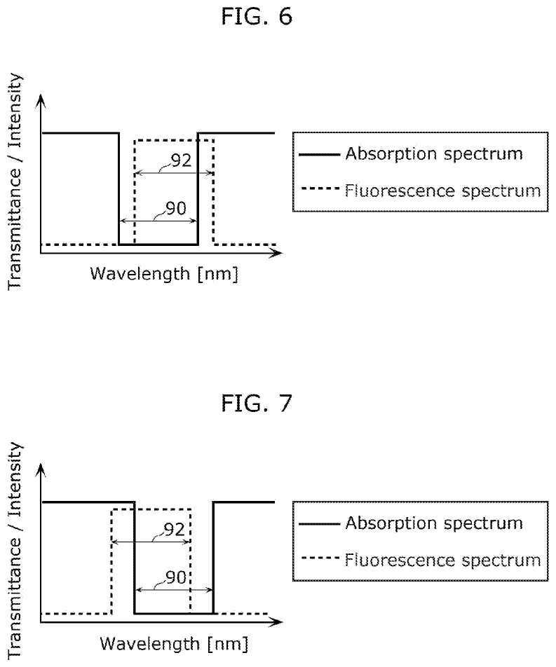

Alternatively, as illustrated in FIG. 7, a band on the long wavelength side of second wavelength band 92 in the fluorescence spectrum and a band on the short wavelength side of first wavelength band 90 in the absorption spectrum may overlap each other. At this time, the band on the short wavelength side of second wavelength band 92 is not included in first wavelength band 90. In addition, the band on the long wavelength side of first wavelength band 90 is not included in second wavelength band 92.

In addition, as illustrated in FIG. 8, first wavelength band 90 in the absorption spectrum may be included in second wavelength band 92 in the fluorescence spectrum, for example. At this time, the end portion on the short wavelength side of first wavelength band 90 may coincide with the end portion on the short wavelength side of second wavelength band 92. Alternatively, the end portion on the long wavelength side of first wavelength band 90 may coincide with the end portion on the long wavelength side of second wavelength band 92. Note that the relationship between these end portions may be similarly applied to the case where second wavelength band 92 in the fluorescence spectrum is included in first wavelength band 90 in the absorption spectrum, as illustrated in FIG. 5.

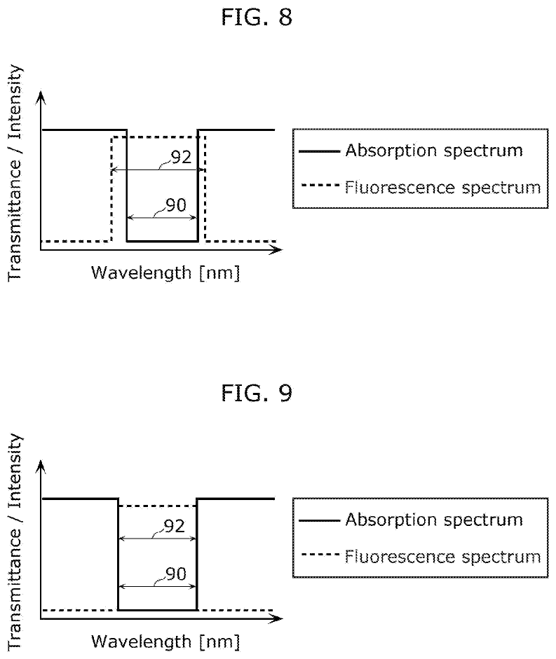

In addition, as illustrated in FIG. 9, first wavelength band 90 in the absorption spectrum may exactly coincide with second wavelength band 92 in the fluorescence spectrum, for example.

Fluorescence emitted by fluorescent material 22 has intensity that cancels out a component absorbed by absorbing material 12. For example, in the case where light having a predetermined intensity enters color vision correction lens 1, the intensity of fluorescence is equivalent to the intensity of a component of the light absorbed by absorbing material 12. An example of the intensity of each of wavelength components of fluorescence is at least 0.5 times the intensity of a wavelength component absorbed by absorbing material 12 and at least 1.5 times the intensity of the wavelength component absorbed by absorbing material 12. Alternatively, the intensity of each wavelength component of fluorescence may fall within the range of from 0.8 times the intensity of a wavelength component absorbed by absorbing material 12 to 1.2 times the intensity of the wavelength component absorbed by absorbing material 12.

### Optical Properties of Color Vision Correction Lens

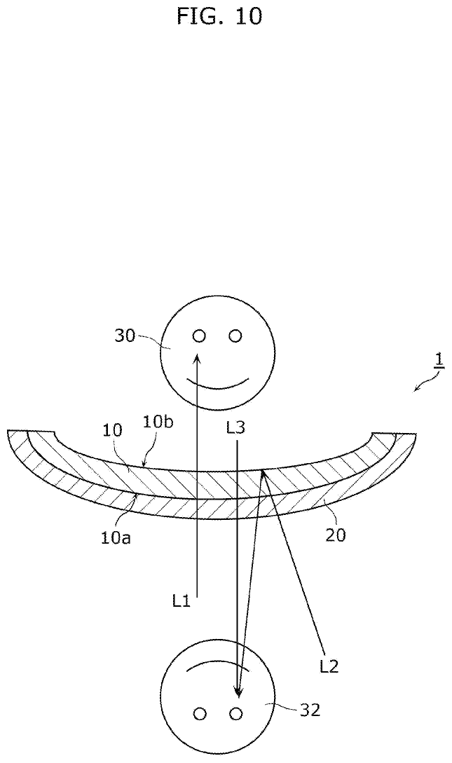

FIG. 10 is a diagram illustrating optical properties of color vision correction lens 1 according to the embodiment. FIG. 10 schematically illustrates user 30 who is a wearer of a pair of eyeglasses, and another person 32 who is different from user 30, in the case where color vision correction lens 1 is used for the pair of eyeglasses. User 30 is a person with color vision deficiency. As illustrated in FIG. 10, color vision correction lens 1 is used such that first resin layer 10 is located on the user 30 side and second resin layer 20 is located on the another person 32 side.

Light L1 that transmits through color vision correction lens 1 from second resin layer 20 to first resin layer 10 in the stated order enters an eye of user 30 who is a person with color vision deficiency. Accordingly, when light L1 passes through second resin layer 20, light L1 excites fluorescent material 22 and produces green light. The produced green light and a green component included in light L1 are absorbed by absorbing material 12 when light L1 passes through first resin layer 10. Consequently, light with a reduced green component enters the eye of user 30. This allows user 30 to keep a perceptional balance between red light and green light, and thus the color vision is corrected. In other words, the function of color vision correction which color vision correction lens 1 has is appropriately demonstrated.

In contrast, as illustrated in FIG. 10, when another person 32 looks at the face of user 30, light L2 that reflects off color vision correction lens 1, and light L3 that has transmitted through color vision correction lens 1 from first resin layer 10 to second resin layer 20 in the stated order enter an eye of another person 32. Light L2 is, for example, light reflected off concave surface 10b which is an interface between first resin layer 10 having a high refractive index and an air space having a low refractive index. In the same manner as light L3, after light L2 is reflected off concave surface 10b, light L2 transmits through color vision correction lens 1 from first resin layer 10 to second resin layer 20 in the stated order.

Accordingly, after the green component of light L2 and the green component of light L3 are absorbed by absorbing material 12 included in first resin layer 10, light L2 and light L3 excite fluorescent material 22 included in second resin layer 20 and produce green light. With this, when light L2 and light L3 pass through second resin layer 20, light L2 and light L3 each are supplemented with a green component that has been reduced when light L2 and light L3 have passed through first resin layer 10. Since light L2 and light L3 which enter the eye of another person 32 are lights each supplemented with a green component that has been reduced due to absorption, another person 32 can perceive light having a color close to the original color of light L2 and light L3 before light L2 and light L3 have passed through color vision correction lens 1.

As has been described above, according to the embodiment, it is possible to realize color vision correction lens 1 that can demonstrate the function of color vision correction for user 30, and has a less tinted appearance when color vision correction lens 1 is seen by another person 32.

### Optical Component

Color vision correction lens 1 described above is used for various optical components.

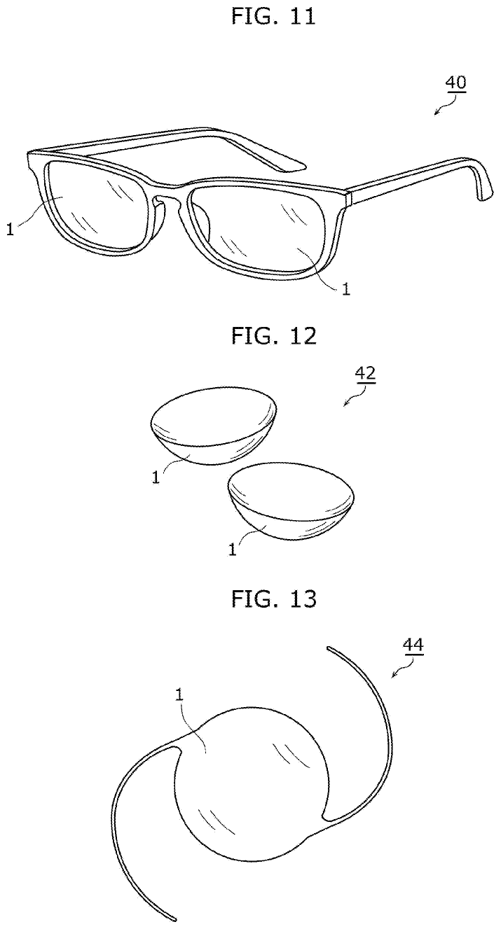

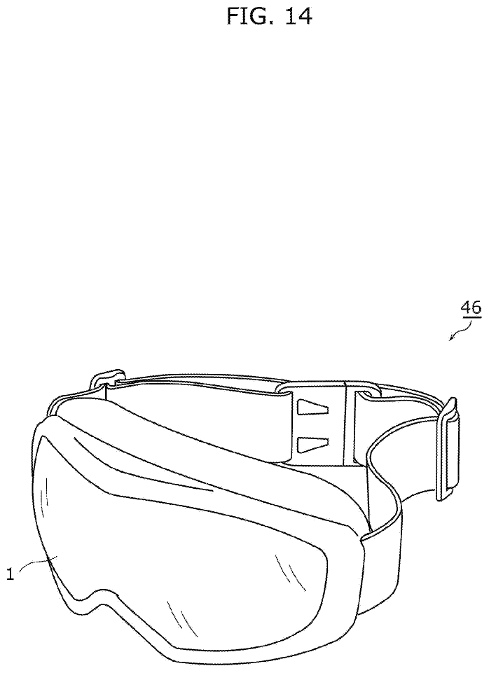

FIG. 11 through FIG. 14 are diagrams each illustrating an example of an optical component provided with at least one color vision correction lens 1 according to the embodiment. Specifically, FIG. 11, FIG. 12, and FIG. 14 are perspective views illustrating pair of eyeglasses 40, contact lenses 42, and pair of goggles 46, respectively. FIG. 13 is a plan view illustrating intraocular lens 44 that is an example of an optical component. For example, as illustrated in each diagram, pair of eyeglasses 40, contact lenses 42, intraocular lens 44, and pair of goggles 46 are provided with at least one color vision correction lens 1.

For example, pair of eyeglasses 40 is provided with two color vision correction lenses 1 for right and left lenses. The entirety of each of contact lenses 42 and intraocular lens 44 may be color vision correction lens 1. Alternatively, the central portion of each of contact lenses 42 and intraocular lens 44 may be color vision correction lens 1. Pair of goggles 46 is provided with one color vision correction lens 1 as a cover lens for covering both eyes.

### Advantageous Effects, Etc.

As has been described above, color vision correction lens 1 according to the embodiment includes first resin layer 10 having convex surface 10a, and second resin layer 20 stacked on convex surface 10a. First resin layer 10 includes absorbing material 12 that absorbs light in first wavelength band 90. Second resin layer 20 includes fluorescent material 22 that emits fluorescence in second wavelength band 92. First wavelength band 90 and second wavelength band 92 overlap at least partially.

With this, a component absorbed by absorbing material 12 is supplemented with fluorescence emitted by fluorescent material 22. Therefore, it is possible for color vision correction lens 1 to have a less tinted appearance when user 30 is seen by another person 32 from the second resin layer 20 side. In contrast, since light emitted by fluorescent material 22 is absorbed by absorbing material 12, light on which the absorption is performed by absorbing material 12 enters the eyes of user 30 who sees from the first resin layer 10 side. Therefore, color vision correction lens 1 can correct the color vision of user 30.

As described above, according to the embodiment, color vision correction lens 1 having a less tinted appearance can be realized while maintaining the function of color vision correction.

In addition, for example, first wavelength band 90 falls within a range of from 440 nm to 600 nm.

With this, it is possible to correct the color vision of a person who is congenitally color-blind to red and green.

In addition, for example, second wavelength band 92 falls within a range of from 440 nm to 600 nm.

With this, it is possible to effectively cancel out the tinted appearance of color vision correction lens 1 resulting from the absorption performed by absorbing material 12.

In addition, for example, fluorescent material 22 emits the fluorescence in response to reception of light having a wavelength ranging from 300 nm to 440 nm.

With this, it is possible for color vision correction lens 1 to have a less tinted appearance since fluorescent material 22 is excited by an ultraviolet light component included in sun light and produces fluorescence having sufficient intensity.

In addition, for example, a refractive index of first resin layer 10 is equal to a refractive index of second resin layer 20.

With this, it is possible to reduce the amount of light reflecting off the interface between first resin layer 10 and second resin layer 20, thereby preventing a reduction in the amount of light that transmits through color vision correction lens 1.

In addition, for example, first resin layer 10 and second resin layer 20 include a same resin material.

With this, the refractive index of first resin layer 10 can be readily rendered equal to the refractive index of second resin layer 20.

In addition, for example, an optical component according to the embodiment includes color vision correction lens 1. The optical component is, for example, pair of eyeglasses 40, contact lenses 42, intraocular lens 44, or pair of goggles 46.

With this, it is possible to realize an optical component, such as a pair of eyeglasses, which is wearable by user 30. Suppose that user 30 wears a pair of eyeglasses whose tinted appearance is not corrected, another person 32 may find the appearance of the pair of eyeglasses somewhat odd. Since pair of eyeglasses 40 can have less tinted appearance according to the embodiment, it is possible to reduce the oddness felt by another person 32 in everyday life.

### Other Embodiments

Although the color vision correction lens and the optical components according to the present invention have been described based on the above-described embodiments, the present invention is not limited to the above-described embodiments.

For example, the refractive index of first resin layer 10 may be different from the refractive index of second resin layer 20. When a difference in the refractive index between first resin layer 10 and second resin layer 20 is large, a middle layer having a refractive index between the refractive index of first resin layer 10 and the refractive index of second resin layer 20 may be provided between first resin layer 10 and second resin layer 20. This reduces the difference in the refractive index at the interface between first resin layer 10 and the middle layer and at the interface between second resin layer 20 and the middle layer, thereby reducing the reflection of light at these interfaces. As such, first resin layer 10 need not be in contact with second resin layer 20. In other words, second resin layer 20 may be stacked above convex surface 10a of first resin layer 10 with another layer interposed therebetween.

In addition, for example, the excitation wavelength of fluorescent material 22 may be longer than the fluorescence wavelength. For example, the excitation wavelength of fluorescent material 22 may fall within the range of from 550 nm to 780 nm. That is, fluorescent material 22 may be an up-conversion phosphor material.

In addition, a part of the first wavelength band, which is the wavelength band of light absorbed by absorbing material 12, may be less than 440 nm, and may be greater than 600 nm, for example. In addition, a part of the second wavelength band, which is the wavelength band of fluorescence emitted by fluorescent material 22, may be less than 440 nm, and may be greater than 600 nm.

In addition, at least one of absorbing material 12 and fluorescent material 22 need not be a dye material, for example.

In addition, the present invention also encompasses: embodiments achieved by applying various modifications conceivable to those skilled in the art to each embodiment; and embodiments achieved by optionally combining the structural elements and the functions of each embodiment without departing from the essence of the present invention.

### REFERENCE SIGNS LIST

1 color vision correction lens
10 first resin layer
10a convex surface
12 absorbing material
20 second resin layer
22 fluorescent material
40 pair of eyeglasses (optical component)
42 contact lenses (optical component)
44 intraocular lens (optical component)
46 pair of goggles (optical component)
90 first wavelength band
92 second wavelength band

1. A color vision correction lens, comprising:
a first resin layer having a convex surface; and
a second resin layer stacked on the convex surface, wherein
the first resin layer includes an absorbing material that absorbs light in a first wavelength band,
the second resin layer includes a fluorescent material that emits fluorescence in a second wavelength band, and
the first wavelength band and the second wavelength band overlap at least partially.

2. The color vision correction lens according to claim 1, wherein
the first wavelength band falls within a range of from 440 nm to 600 nm.

3. The color vision correction lens according to claim 1, wherein
the second wavelength band falls within a range of from 440 nm to 600 nm.

4. The color vision correction lens according to claim 1, wherein
the fluorescent material emits the fluorescence in response to reception of light having a wavelength ranging from 300 nm to 440 nm.

5. The color vision correction lens according to claim 1, wherein
a refractive index of the first resin layer is equal to a refractive index of the second resin layer.

6. The color vision correction lens according to claim 1, wherein
the first resin layer and the second resin layer include a same resin material.

7. An optical component, comprising:
the color vision correction lens according to claim 1.

8. The optical component according to claim 7, wherein
the optical component is a pair of eyeglasses, a contact lens, an intraocular lens, or a pair of goggles.
